(19) United States
(12) Patent Application Publication
(10) Pub. No.: US 2023/0415862 A1
(43) Pub. Date: Dec. 28, 2023

(54) Marine Vessel Fender and Control System

(71) Applicant: C W F HAMILTON & CO LIMITED, Christchurch (NZ)

(72) Inventors: Christopher William Johansson, Christchurch (NZ); Diego Muller De Oliveira, Christchurch (NZ); Benjamin Elliot Reed, Christchurch (NZ)

(21) Appl. No.: 18/253,121

(22) PCT Filed: Dec. 16, 2021
(86) PCT No.: PCT/NZ2021/050223

§ 371 Date: May 16, 2023

(30) Foreign Application Priority Data
Dec. 17, 2020 (NZ) 771252

(51) Int. Cl. B63B 59/02; B63B 79/10; B63H 25/46; B63H 11/10

(52) U.S. Cl. CPC B63B 59/02; B63B 79/10; B63H 25/46; B63H 11/101

(57) ABSTRACT

Maintenance personnel need to be safely transferred to offshore structures from marine vessels in varying sea and weather conditions. Disclosed herein is a control system for a marine vessel (100) having a propulsion and steering system (101) and a fender arrangement (102) at the bow of the marine vessel to provide contact between the marine vessel and an external structure (103). The control system comprises force, pressure, torque or strain sensors and a controller. The force, pressure, torque or strain sensors measure force, pressure, torque or strain that are indicative of forces between the fender arrangement (102) and the external structure (103). The controller controls the operation of the propulsion and steering system (101) to substantially obtain or maintain desired forces between the fender arrangement (102) and the external structure (103) based on the force, pressure, torque or strain measurements from the force, pressure, torque or strain sensors.

### FIELD OF THE INVENTION

The invention relates to a marine vessel fender and control system.

### BACKGROUND

Offshore wind turbines, oil platforms, and similar structures require periodic maintenance. In order to transfer maintenance personnel to these structures, sea going vessels must get close enough to allow people to safely move from the vessel to the structure. This must be done in varying sea and weather conditions, often in harsh marine environments.

A typical way of effecting these transfers is for a vessel to push up against the structure to hold the vessel stationary against the structure while personnel and equipment can be transferred to or from the structure.

Due to the harsh sea and wind conditions encountered near these structures, it can be difficult for the operator of the vessel to maintain a relatively constant force against the structure. Large waves or wind gusts can cause the vessel to move resulting in danger to personnel and equipment.

Another problem is that the offshore structures can be damaged if a vessel impacts too hard while attempting to contact them. Impact can be caused by the vessel operator approaching too rapidly or by inadvertent waves forcing the vessel to hit the structure.

Similar issues can be encountered by marine vessels while approaching jetties, piers, or other structures, in the ocean, rivers, or lakes.

An object of at least an embodiment of the present invention is to provide a control system for a marine vessel that addresses at least one of the above problems. An additional or alternative object of at least an embodiment of the present invention is to provide the public with a useful choice.

### SUMMARY OF THE INVENTION

In accordance with a first aspect of the present invention, there is provided a control system for a marine vessel having a propulsion and steering system and a fender arrangement at the bow of the marine vessel to provide contact between the marine vessel and an external structure. The control system comprises at least two force, pressure, torque or strain sensors to measure force, pressure, torque or strain that are indicative of forces between the fender arrangement and the external structure. The control system further comprises a controller to control the operation of the propulsion and steering system of the marine vessel to substantially obtain or maintain desired forces between the fender arrangement and the external structure based on the force, pressure, torque or strain measurements from the at least two force, pressure, torque or strain sensors.

Different combinations of force, pressure, torque or strain sensors can be used. In one example, the control system comprises one force sensor or pressure sensor and one strain sensor or torque sensor. In another example, the control system comprises two of the same type of sensors. In other words, the control system comprises at least two sensors that each measure force, pressure, torque or strain.

Different configurations of the propulsion and steering system may have propulsion and steering components that can be positioned together or separately on the marine vessel and/or controlled together or separately by the controller.

In an embodiment, a sum of the desired forces forms a target force.

In an embodiment, the controller is configured to increase a forward thrust vector applied by the propulsion and steering system if a sum of the forces between the fender arrangement and the external structure is below the target force.

In an embodiment, the controller is configured to reduce a forward thrust vector applied by the propulsion and steering system if a sum of the forces between the fender arrangement and the structure is above the target force.

In an embodiment, the controller is configured to adjust engine RPM of the propulsion and steering system and/or to adjust a position of a reverse deflector of a waterjet unit of the propulsion and steering system and/or to adjust a pitch of a propeller of the propulsion and steering system to increase or reduce the forward thrust vector.

In an embodiment, the at least two force, pressure, torque or strain sensors comprise at least one port-side sensor to measure force, pressure, torque or strain that is indicative of at least one port-side force between a port side of the fender arrangement and the external structure, and at least one starboard-side sensor to measure force, pressure, torque or strain that is indicative of at least one starboard-side force between a starboard side of the fender arrangement and the external structure. The desired forces comprise at least one desired port-side force between the port side of the fender arrangement and the external structure and at least one desired starboard-side force between the starboard side of the fender arrangement and the external structure.

In an embodiment, the controller is configured to control the propulsion and steering system to produce a yaw effect to increase the at least one starboard-side force and/or decrease the at least one port-side force if the at least one starboard-side force is lower than the at least one desired starboard-side force and/or if the at least one port-side force is higher than the at least one desired port-side force; or control the steering and propulsion system to produce a yaw effect to increase the at least one port-side force and/or decrease the at least one starboard-side force if the at least one port-side force is lower than the at least one desired port-side force and/or if the at least one starboard-side force is higher than the at least one desired starboard-side force.

In an embodiment, the controller is configured to adjust steering of the propulsion and steering system and/or to adjust differential engine RPM of the propulsion and steering system and/or to adjust differential positions of reverse deflectors of waterjet units of the propulsion and steering system and/or to adjust the differential pitch of propellers of the propulsion and steering system and/or to adjust thrust of a bow and/or stern thruster of the propulsion and steering system to produce the yaw effect.

In an embodiment, the control system further comprises at least one wind sensor. The controller is configured in response to signals from the wind sensor to determine a required operation of the propulsion and steering system of the marine vessel to obtain or maintain desired forces between the fender arrangement and the external structure based on the force, pressure, torque or strain measurements from the at least two force, pressure, torque or strain sensors.

In an embodiment, the control system further comprises at least one wave sensor, wherein the controller is configured in response to signals from the wave sensor to determine a required operation of the propulsion and steering system of the marine vessel to obtain or maintain a desired force or pressure between the fender arrangement and the external structure based on the force, pressure, torque or strain measurements from the at least two force, pressure, torque or strain sensors.

In an embodiment, the wave sensor is a distance sensor, an optical sensor, radar sensor and/or a wave speed sensor.

In an embodiment, the control system further comprises at least one inertial measurement unit (IMU). The controller is configured in response to signals from the IMU to determine a required operation of the propulsion and steering system of the marine vessel to obtain or maintain desired attitude.

In an embodiment, the control system further comprises at least one data storage to record the force, pressure, torque or strain measurements from the at least two force, pressure, torque or strain sensors, forces between the fender arrangement and the external structure and/or desired forces between the fender arrangement and the external structure.

In accordance with a second aspect of the present invention, there is provided a marine vessel. The marine vessel comprises a propulsion and steering system, a fender arrangement positioned at the bow of the marine vessel, and a control system in accordance with the first aspect. The at least two force, pressure, torque or strain sensors are associated with the fender arrangement and configured to obtain force, pressure, torque or strain measurements indicative of forces between the fender arrangement and the external structure.

In an embodiment, the control system is configured to control the propulsion and steering system for a sum of the forces between the fender arrangement and the external structure to be substantially the same as the target force.

In an embodiment, the control system is configured to increase a forward thrust vector applied by the propulsion and steering system if the sum of the forces between the fender arrangement and the external structure is below the target force.

In an embodiment, the control system is configured to reduce a forward thrust vector applied by the propulsion and steering system if the sum of the forces between the fender arrangement and the external structure is above the target force.

In an embodiment, the control system is configured to adjust engine RPM of the propulsion and steering system and/or to adjust a position of a reverse deflector of a waterjet unit of the propulsion and steering system and/or to adjust a pitch of a propeller of the propulsion and steering system to increase or reduce the forward thrust vector.

In an embodiment, the at least one port-side sensor is positioned substantially at the port side of the fender arrangement and the at least one starboard-side sensor is positioned substantially at the starboard side of the fender arrangement.

In an embodiment, the control system is configured to control the propulsion and steering system to produce a yaw effect to apply more force between the starboard side of the fender arrangement and the structure and/or less force between the port side of the fender arrangement and the structure if the at least one starboard-side force is lower than the at least one desired starboard-side force and/or if the at least one port-side force is higher than the at least one desired port-side force. The control system is configured to control the propulsion and steering system to produce a yaw effect to apply more force to the port side of the fender and/or less force to the starboard side of the fender arrangement if the at least one port-side force is lower than the at least one desired port-side force and/or if the at least one starboard-side force is higher than the at least one desired starboard-side force.

In an embodiment, the control system is configured to adjust steering of the propulsion and steering system and/or to adjust differential engine RPM of the propulsion and steering system and/or to adjust differential positions of reverse deflectors of waterjet units of the propulsion and steering system and/or to adjust the differential pitch of propellers of the propulsion and steering system and/or to adjust thrust of a bow and/or stern thruster of the propulsion and steering system to produce the yaw effect.

In an embodiment, some or all of the at least two force, pressure, torque or strain sensors are configured to obtain force, pressure, torque or strain measurements in a substantially longitudinal direction of the marine vessel.

In an embodiment, some or all of the at least two force, pressure, torque or strain sensors are configured to obtain force, pressure, torque or strain measurements in substantially vertical direction(s) relative to the length of the marine vessel.

In an embodiment, some or all of the at least two force, pressure, torque or strain sensors are configured to obtain force, pressure, torque or strain measurements in substantially lateral direction(s) relative to the length of the marine vessel.

In accordance with a third aspect of the present invention, there is provided a method for controlling a marine vessel having a propulsion and steering system, a fender arrangement at the bow of the marine vessel to provide contact between the marine vessel and an external structure, and a control system in accordance with the first aspect. The method comprises receiving a first set of desired forces between the fender arrangement and the external structure. The method further comprises determining a current set of forces between the fender arrangement and the external structure based on the force, pressure, torque or strain measurements from at least two force, pressure, torque or strain sensors associated with the fender arrangement. The method further comprises controlling the propulsion and steering system of the marine vessel so that the current set of forces substantially matches the first set of desired forces.

In an embodiment, the method further comprises receiving a second set of desired forces between the fender arrangement and the external structure. The method further comprises controlling the propulsion and steering system of the marine vessel so that the current set of forces substantially matches the second set of desired forces after the current set of forces substantially matches the first set of desired forces for a time period.

In an embodiment, the method comprises receiving a first target force that is a sum of the first set of desired forces and/or receiving a second target force that is a sum of the second set of desired forces.

In an embodiment, the propulsion and steering system is controlled to apply an increased forward thrust vector if a sum of the current set of forces is below the first target force or second target force.

In an embodiment, the propulsion and steering system is controlled to apply a reduced forward thrust vector if a sum of the current set of forces is above the first target force or second target force.

In an embodiment, the propulsion and steering system is controlled to adjust engine RPM of the propulsion and steering system and/or to adjust the position of a reverse deflector of a waterjet unit of the propulsion and steering system and/or to adjust a pitch of a propeller of the propulsion and steering system to increase or reduce the forward thrust vector.

In an embodiment, the current set of forces comprise at least one port-side force between the port side of the fender arrangement and the external structure, and at least one starboard-side force between the starboard side of the fender arrangement and the external structure. The first set or second set of desired forces each comprise at least one desired port-side force and at least one desired starboard-side force.

In an embodiment, the propulsion and steering system is controlled to produce a yaw effect to increase the at least one starboard-side force and/or decrease the at least one port-side force if the at least one starboard-side force is lower than the at least one desired starboard-side force and/or if the at least one port-side force is higher than the at least one desired port-side force. The propulsion and steering system is controlled to produce a yaw effect to increase the at least one port-side force and/or decrease the at least one starboard-side force if the at least one port-side force is lower than the at least one desired port-side force and/or if the at least one starboard-side force is higher than the at least one desired starboard-side force.

In an embodiment, the propulsion and steering system is controlled to adjust steering of the propulsion and steering system and/or to adjust differential engine RPM of the propulsion and steering system and/or to adjust differential positions of reverse deflectors of waterjet units of the propulsion and steering system and/or to adjust the differential pitch of propellers of the propulsion and steering system and/or to adjust thrust of a bow and/or stern thruster of the propulsion and steering system to produce the yaw effect.

In an embodiment, some or all of the current set of forces, the first set of desired forces and/or the second set of desired forces are in a substantially longitudinal direction of the marine vessel.

In an embodiment, some or all of the current set of forces, the first set of desired forces and/or the second set of desired forces are in a substantially vertical direction(s) relative to the length of the marine vessel.

In an embodiment, wherein some or all of the current set of forces, the first set of desired forces and/or the second set of desired forces are in a substantially lateral direction(s) relative to the length of the marine vessel.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both.

The invention consists in the foregoing and also envisages constructions of which the following gives examples only.

### BRIEF DESCRIPTION OF THE DRAWINGS

The present invention will now be described by way of example only and with reference to the accompanying drawings in which:

FIG. 1 is a schematic view a marine vessel in relation to an external structure;

FIG. 2 is a schematic arrangement of an embodiment of a force sensing fender control system;

FIG. 3 is a schematic arrangement of another embodiment of a force sensing fender control system;

FIGS. 4a-4e are schematic views of exemplary fender arrangements;

FIG. 5 shows exemplary vessel manoeuvres with a propulsion and steering system that has a twin waterjet configuration;

FIGS. 6a-6d are schematic views of exemplary propulsion and steering systems;

FIG. 7 is a flow diagram of a method carried out by the controller of a force sensing fender control system;

FIG. 8 is a schematic view demonstrating fender force control of the marine vessel in relation to the external structure;

FIG. 9 is a schematic arrangement of another embodiment of a force sensing fender control system

### DETAILED DESCRIPTION OF EMBODIMENTS

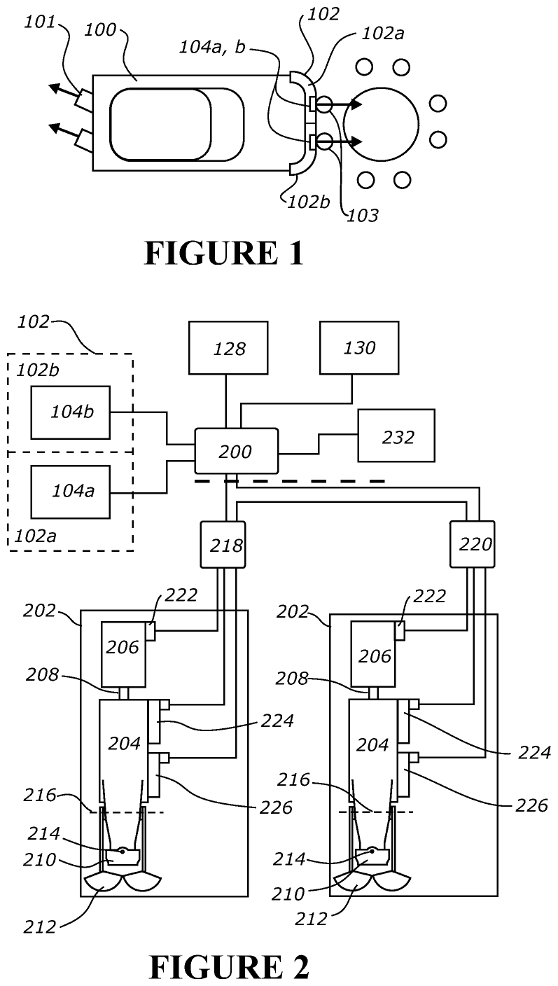

FIG. 1 shows a marine vessel 100 having a propulsion and steering system 101 and a fender arrangement 102. The fender arrangement 102 provides contact between the marine vessel 100 and an external structure 103. The external structure 103 shown in FIG. 1 comprises stanchions of a wind turbine tower. A skilled person will understand that a marine vessel can be operated on a body of water such as a sea or ocean, or on a different type of body of water such as a lake or river for example.

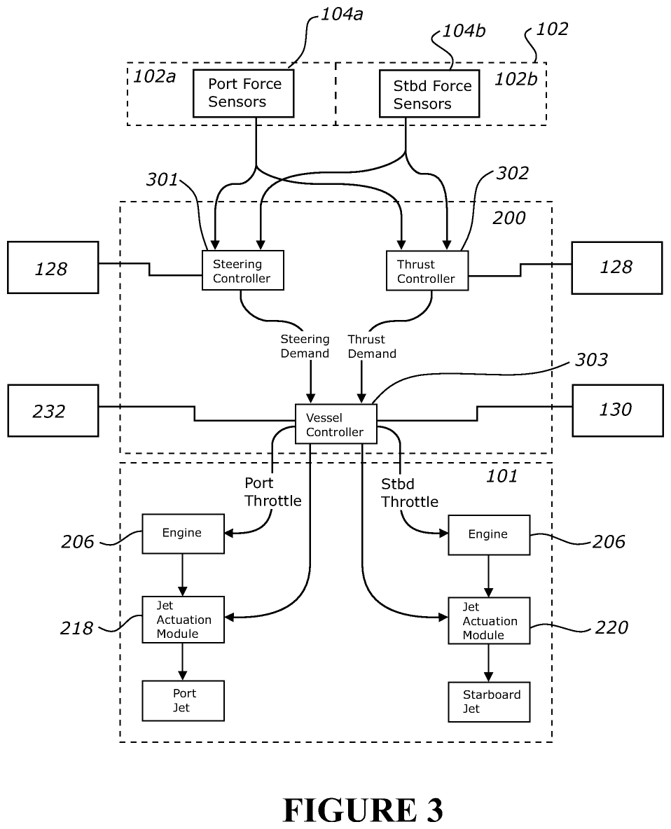

Force, pressure, torque or strain sensors 104 are part of a control system for the marine vessel 100. Referring to FIGS. 2 and 3, the control system also has a controller 200.

The controller 200 controls the operation of the propulsion and steering system 101 of the marine vessel 100 to substantially obtain or maintain desired forces between the fender arrangement 102 and the external structure 103. The controller 200 is a microprocessor, microcontroller, programmable logic controller (PLC) or the like programmed to receive and process data.

The controller 200 may be a stand-alone or dedicated controller for fender force control or preferably is incorporated into an existing vessel controller. In one form, the controller 200 is a plug-in module that is connected to a network, such as a Controller Area Network (CAN), in the marine vessel 100.

The controller 200 receives inputs to effect vessel control. One input comes from one or more vessel control devices 128, such as one or more joysticks, helm controls, throttle levers or the like. The vessel control device(s) 128 is used by a helmsperson to manually operate the vessel.

The controller 200 also receives input from one or more fender force control input devices 130 which may be operated to enable a fender force control mode, such as one or more buttons, switches, keypads or the like. The fender force control input device(s) 130 is used by the helmsperson to enable and operate a fender force control mode.

When the fender force control mode is enabled, the controller 200 controls the propulsion and steering system 101 of the vessel 100 to substantially obtain or maintain desired forces between the fender arrangement and the external structure. Otherwise, the helmsperson would manually operate the vessel 100.

The controller 200 also receives input from force, pressure, torque or strain sensor(s) 104a, 104b that measure the force, pressure, torque or strain between the fender arrangement 102 and the external structure 103. These measured parameters are used by the controller 200 to obtain force values at points of contact between the vessel 100 and the external structure 103. The forces that are indicated by the force, pressure, torque or strain sensors 104a, 104b are used by the controller 200 to determine whether or not the desired forces between the fender arrangement 102 and the external structure 103 have been achieved.

A sum of the desired forces between the fender arrangement 102 and the external structure 103 forms a target force. The controller 200 controls the propulsion and steering system for a sum of the forces between the fender arrangement 102 and the external structure 103 to be substantially the same as the target force.

The target force is set by the helmsperson or operator via fender force control input device(s) 130, such as a keypad. The target force may indicate a maximum overall force that may be applied to the external structure 103 to prevent damage to the external structure 103. The target force may also be set to prevent damage to the vessel 100.

The maximum force that may be applied to the external structure 103 is based on the sum of forces applied through all points of contact between the vessel 100 and the external structure 103. To illustrate, if the maximum force value is 50 N and there are two points of contact between the vessel and the external structure 103, the vessel can apply an even 25 N force through each point of contact as an example. In another example, the vessel can also apply an uneven ratio of 20 N and 30 N forces through the respective points of contact. Any combination of uneven forces can be applied as long as the sum of forces do not exceed the maximum force. The forces applied at each point of contact would be measured using the force, pressure, torque or strain sensors 104.

Accordingly, the desired forces each form a portion of the target force. The desired forces at each point of contact may vary as long as the sum of the desired forces do not exceed the target force. A ratio between the desired forces can be set by the helmsperson using fender force control input device(s) 130. If the helmsperson sets a new target force, the controller 200 can adjust the sum of forces applied against the external structure while maintaining the ratio between the forces at respective points of contact.

To provide more stability to the vessel 100, the helmsperson may set the ratio of the desired forces to be equal. In cases where wind or waves apply external forces to the vessel, the helmsperson may set the ratio of the desired forces to be uneven to anticipate and compensate for the external forces.

Alternatively, the target force is set automatically as the sum of the forces indicated by the force, pressure, torque or strain measurements from the force, pressure, torque or strain sensors 104 at the time when the fender force control mode is enabled. The ratio of the desired forces can also be set automatically at the time the fender force control mode is enabled.

If the sum of the forces between the fender arrangement and the external structure is below the target force or if most of the measured forces at points of contact are less than the respective desired forces, the controller increases a forward thrust vector applied by the propulsion and steering system 101. Conversely, if the sum of the forces between the fender arrangement and the external structure is above the target force or if most of the measured forces at points of contact are greater than the respective desired forces, the controller reduces a forward thrust vector applied by the propulsion and steering system 101. To obtain or maintain desired forces at a certain ratio, the controller 200 controls the propulsion and steering system 101 to apply a yaw effect to the vessel 100.

Referring to FIG. 3, the controller 200 may have a steering controller 301, a thrust controller 302 and a vessel controller 303 as an example. The vessel control device(s) 128 provides inputs to the steering controller 301 and the thrust controller 302. The steering controller 301 and thrust controller 302 provide corresponding steering demand and thrust demand to the vessel controller 303 that controls the propulsion and steering system 101 of the marine vessel 100. In another example, the required steering and trust can be determined in a single steering and thrust controller that provides both the steering demand and thrust demand to the vessel controller 303.

A data storage 232 records the force, pressure, torque or strain measurements from the force, pressure, torque or strain sensors, forces between the fender arrangement and the external structure and/or desired forces between the fender arrangement and the external structure. The recorded parameters can be used for later analysis by the helmsperson or operators of the external structure 103. For example, the recorded parameters can be used to check whether forces above an allowable target force have been applied to the external structure by the vessel.

As shown in FIGS. 1 to 3 The fender arrangement 102 is positioned at the bow of the marine vessel 100. In the form shown, the fender arrangement 102 has two fenders 102a, 102b and two force, pressure, torque or strain sensors 104a, 104b associated with the fender arrangement. In the configuration shown, the force, pressure, or strain sensors 104a, 104b are each on one fender. The force, pressure, torque or strain sensors 104 are configured to obtain force, pressure, torque or strain measurements indicative of forces between the fender arrangement 102 and the external structure 103. The determined forces between the fender arrangement 102 and the external structure are used by the controller 200 to obtain or maintain desired forces between the fender arrangement and the external structure.

In an example, the force or pressure sensors can obtain force or pressure measurements directly at points of contact between the fender arrangement 102 and the external structure 103. In another example, the torque or strain sensors can measure the amount of deformation of the fender arrangement 102 as a result of impact between the fender arrangement 102 and the external structure 103. The deformations of the fender arrangement 102 caused by torque or strain can be used to determine the amount of force applied to the fender arrangement 102 and/or external structure 103.

The fender is a bumper positioned on an external surface of the marine vessel. The fender provides contact between the vessel and an external structure. The fender may also absorb kinetic energy to prevent damage to the vessel or external structure. The fenders of the vessel 100 may be made from materials such as rubber, foam elastomer, metal, or plastic for example. The fenders of the vessel 100 may be of different shapes such as cylindrical, arch, cone, D-type, rectangular, fan-shaped or drum-shaped. Preferably, the arrangement of the fenders conforms to the shape of the bow of the marine vessel 100.

FIGS. 1 to 3 show a port-side sensor 104a positioned substantially at the port side of the fender arrangement 102 (on fender 102a) to measure force, pressure, torque or strain that is indicative of a port-side force between a port side of the fender arrangement 102 and the external structure 103. FIGS. 1 to 3 also show a starboard-side sensor 104b positioned substantially at the starboard side of the fender arrangement 102 (on fender 102b) to measure force, pressure, torque or strain that is indicative of a starboard-side force between a starboard side of the fender arrangement 102 and the external structure 103.

When the fender force control mode is enabled, the controller 200 uses the inputs from port-side sensor 104a and starboard-side sensor 104b to maintain the desired forces between the fender arrangement 102 and the structure 103. The desired forces include desired port-side force(s) and desired starboard-side force(s) between the respective sides of the fender arrangement 102 and external structure 103. The sum of the desired port-side force(s) and desired starboard-side force(s) is the target force.

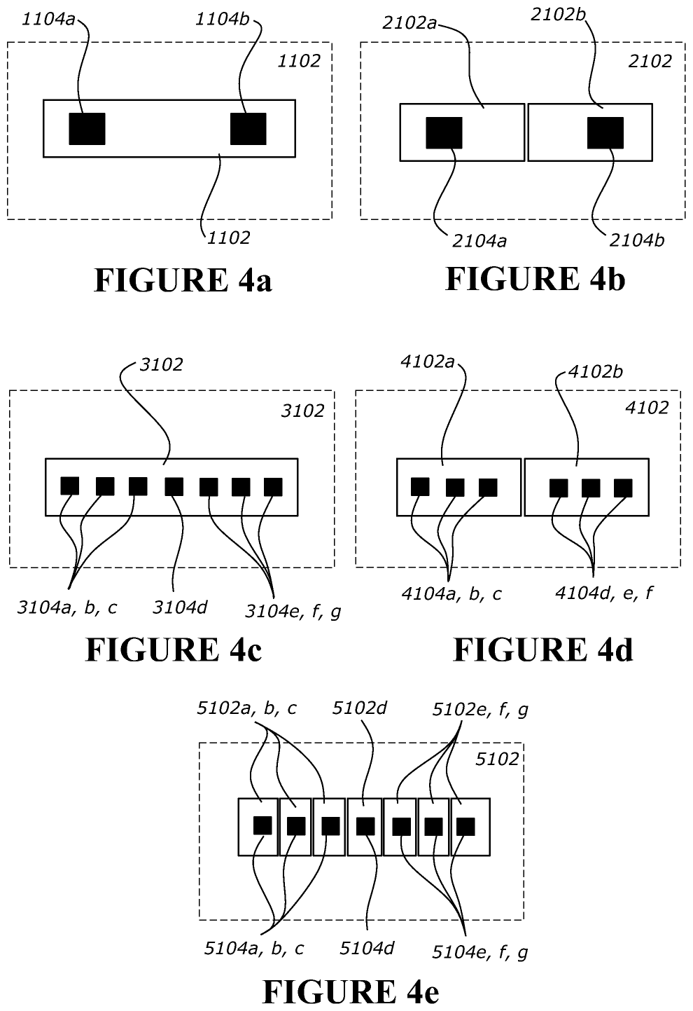

FIGS. 4a-4e show other exemplary fender arrangements with different configurations of sensors. A fender arrangement may have a single fender, two fenders or multiple fenders. Each fender of the fender arrangement may have one or more than one force, pressure, torque or strain sensors associated with the fender arrangement. Like reference numbers indicate like parts with the addition of 1000, 2000, 3000, 4000, and 5000 respectively.

FIG. 4a shows a fender arrangement 1102 with one fender associated with two force, pressure, torque or strain sensors 1104a, 1104b. Force, pressure, torque or strain sensor 1104a is a port-side sensor and force, pressure, torque or strain sensor 1104b is a starboard-side sensor.

FIG. 4b shows a fender arrangement 2102 with two fenders: a port-side fender 2102a and a starboard-side fender 2102b. Each of the fenders has an associated force, pressure, torque or strain sensor. Force, pressure, torque or strain sensor 2104a is a port-side sensor and force, pressure, torque or strain sensor 2104b is a starboard-side sensor.

FIG. 4c shows a fender arrangement 3102 with one fender associated with multiple force, pressure, torque or strain sensors 3104a-3104g. Force, pressure, torque or strain sensors 3104a-3104c are port-side sensors and force, pressure, torque or strain sensors 3104e-3104g are starboard-side sensors.

FIG. 4d shows a fender arrangement 4102 with two fenders: a port-side fender 4102a and a starboard-side fender 4102b. Each of the fenders is associated with a plurality of force, pressure, torque or strain sensors 4104a-4104c or 4104d-4104f. Force, pressure, torque or strain sensors 4104a-4104c are port-side sensors and force, pressure, torque or strain sensors 4104d-4104f are starboard-side sensors.

FIG. 4e shows a fender arrangement 5102 with a plurality of fenders 5102a-5102g. fenders 5102a-5102c are port-side fenders and fenders 5102e-5102g are starboard-side fenders. Each of the fenders 5102a-5102g is associated with a respective force, pressure, torque or strain sensor 5104a-5104g. Force, pressure, torque or strain sensors 5104a-5104c are port-side sensors and force, pressure, torque or strain sensors 5104e-5104g are starboard-side sensors.

Fender arrangements shown in FIGS. 4c-4e can obtain more than one port-side force and/or more than one starboard-side force that can be used to indicate the variation or profile of forces against the external structure 103 at the port region and/or starboard region of the fender arrangements 3102, 4102, 5102. In FIGS. 4d and 4e, fender 4102a and fenders 5102a-5102c substantially forms the port region while fender 4102b and fenders 5102e-5102g substantially forms the starboard region. In FIGS. 4c and 4e, force, pressure, torque or strain sensors 3104d and 5104d in combination with port-side sensors 3104a-3104c, 5104a-5104c and starboard-side sensors 3104e-3104g, 5104e-5104g can be used to indicate the variation or profile of forces against the external structure across the whole of the fender arrangements 3102 and 5102.

The number and spacing of the force, pressure, torque or strain sensors 104a-104b, 1104a-1104b, 2104a-2104b, 3104a-3104g, 4104a-4104f, 5104a-5104g on the fenders 102a-102b, 1102, 2102a-2102b, 3102, 4102a-4102b, 5102a-5102g determines the resolution of the profile of forces between the fender arrangements 102, 1102, 2102, 3102, 4102, 5102 and the external structure 103. For example, fender arrangements 3102, 4102, 5102 in FIGS. 4c-4e can create a higher resolution of the profile of forces than fender arrangements 102, 1102, 2102 in FIGS. 1-3, 4a and 4b.

The points of contact between the fender arrangement 102, 1102, 2102, 3102, 4102, 5102 and the external structure 103 may not always be at the positions of the force, pressure, torque or strain sensors 104. In an example, each fender 102a-102b, 1102, 2102a-2102b, 3102, 4102a-4102b, 5102a-5102g may behave in a similar way to a hot water bottle or balloon filled with gas to more accurately measure the force, pressure, torque or strain between the fenders 102a-102b, 1102, 2102a-2102b, 3102, 4102a-4102b, 5102a-5102g and the external structure 103 from any point of contact.

Force, pressure, torque or strain sensors 104, 104a-104b, 1104a-1104b, 2104a-2104b, 3104a-3104g, 4104a-4104f, 5104a-5104g can also be associated with the fender arrangement 102, 1102, 2102, 3102, 4102, 5102 in a different way to being configured to directly measure forces between the fenders 102a-102b, 1102, 2102a-2102b, 3102, 4102a-4102b, 5102a-5102g and the external structure 103. In an example, force, pressure, torque or strain sensors 104a-104b, 1104a-1104b, 2104a-2104b, 3104a-3104g, 4104a-4104f, 5104a-5104g are strain gauge sensors that are built into the structure of the bow rather than the fender(s) 102a-102b 1102, 2102a-2102b, 3102, 4102a-4102b, 5102a-5102g. The strain gauge sensors would sense strain of metal at the bow of the vessel 100 to indirectly measure forces experienced by the fender(s) 102a-102b, 1102, 2102a-2102b, 3102, 4102a-4102b, 5102a-5102g.

In some configurations of the fender arrangement 102, 1102, 2102, 3102, 4102, 5102, some or all of the force, pressure, torque or strain sensors 104, 104a-104b, 1104a-1104b, 2104a-2104b, 3104a-3104g, 4104a-4104f, 5104a-5104g are normally configured to obtain force, pressure, torque or strain measurements in a substantially longitudinal direction of the marine vessel 100. The controller 200 will be configured to control the operation of the propulsion and steering system 101 to obtain or maintain desired forces in the longitudinal direction between the fender arrangement 102 and the external structure 103 based on the force, pressure, torque or strain measurements in the longitudinal direction.

In some example configurations of the fender arrangement 102, 1102, 2102, 3102, 4102, 5102, some or all of the force, pressure, torque or strain sensors 104, 104a-104b, 1104a-1104b, 2104a-2104b, 3104a-3104g, 4104a-4104f, 5104a-5104g are configured to obtain force, pressure, torque or strain measurements in substantially vertical direction(s) relative to the length of the marine vessel 100. In this case, the controller 200 may be configured to control the operation of the propulsion and steering system 101 to obtain or maintain desired forces in the vertical direction between the fender arrangement 102, 1102, 2102, 3102, 4102, 5102 and the external structure 103 based on the force, pressure, torque or strain measurements in the vertical direction.

In some example configurations of the fender arrangement 102, 1102, 2102, 3102, 4102, 5102, some or all of the force, pressure, torque or strain sensors 104, 104a-104b, 1104a-1104b, 2104a-2104b, 3104a-3104g, 4104a-4104f, 5104a-5104g are configured to obtain force, pressure, torque or strain measurements in substantially lateral direction(s) relative to the length of the marine vessel 100. In this case, the controller 200 may be configured to control the operation of the propulsion and steering system 101 to obtain or maintain desired forces in the lateral direction between the fender arrangement 102, 1102, 2102, 3102, 4102, 5102 and the external structure 103 based on the force, pressure, torque or strain measurements in the lateral direction.

The controller 200 controls operation of the propulsion and steering system 101. The propulsion and steering system can apply a thrust vector in a longitudinal direction of the vessel 100 to move the vessel forwards or backwards. The propulsion and steering system can also apply a yaw effect to turn the vessel 100.

The propulsion and steering system 101 is able to apply an increased or decreased forward thrust vector as the controller 200 matches the measured forces to the desired forces on the fender arrangement 102. The propulsion and steering system 101 can be used for a marine vessel 100 having any of the other fender arrangements 1102-5102.

The propulsion and steering system 101 is also able to produce a yaw effect to allow different portions of fender arrangement 102 to apply different forces against the external structure 103. An anti-clockwise yaw effect can apply more force between the starboard side of the fender arrangement 102 and the external structure 103 while applying less force between the port side of the fender arrangement 102 and the external structure 103. A clockwise yaw effect can apply less force between the starboard side of the fender arrangement 102 and the external structure 103 while applying more force between the port side of the fender arrangement 102 and the external structure 103.

If the controller 200 determines that the starboard-side force is lower than the desired starboard-side force and/or that the port-side force is higher than the desired port-side force, the controller 200 controls the propulsion and steering system 101 to produce an anti-clockwise yaw effect. If the controller determines that the port-side force is lower than the port-side force and/or that the starboard-side force is higher than the desired starboard side, the controller 200 controls the propulsion and steering system 101 to produce a clockwise yaw effect.

Referring to FIGS. 2 and 3, one exemplary configuration of the propulsion and steering system has port and starboard waterjet units 202 at the stern of the vessel (‘twin waterjet vessel’). Alternatively, the propulsion and steering system with a waterjet configuration may only have a single waterjet unit or more than two waterjet units, such as three or four waterjet units for example.

Each waterjet unit 202 comprises a housing containing a pumping unit 204 driven by an engine 206 through a driveshaft 208. Each waterjet unit also includes a steering deflector 210 and a reverse duct 212. In the form illustrated, each reverse duct 212 is of a type that features split passages to improve reverse thrust. The split-passage reverse duct 212 also affects the steering thrust to port and starboard when the duct is lowered into the jet stream. The steering deflectors 210 pivot about generally vertical axes 214 while the reverse ducts 212 pivot about generally horizontal axes 216, independently of the steering deflectors. The engine 206, steering deflector 210 and reverse duct 212 of each unit is actuated by signals received from the actuation modules 218 and 220 through control input ports 222, 224 and 226 respectively. The actuation modules 218 and 220 are in turn controlled by the controller 200.

The controller 200 operates the waterjet units 202 and in particular one or more of engine thrust, steering deflectors 210, and reverse ducts 212, in synchronism or differentially, to maintain or obtain desired forces between the fender arrangement 102 and the external structure 103.

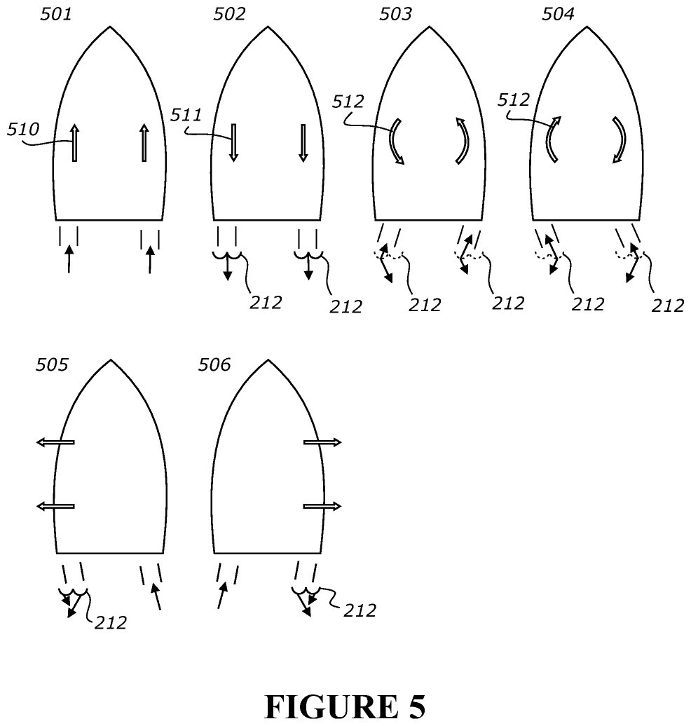

FIG. 5 shows the basic manoeuvres of a vessel 100 with two waterjet units 202 in the propulsion and steering system 101 shown in FIGS. 2 and 3. For simplicity, the reverse ducts 212 when lowered are shown, the reverse ducts 212 when raised are not shown. The reverse ducts 212 when partially lowered are shown with dashed lines.

Manoeuvre numbered 501 shows the vessel 100 applying a forward thrust 510. Manoeuvre numbered 502 shows the vessel 100 applying a rearward thrust 511. The engine RPM of the propulsion and steering system 101 with the waterjet configuration can be increased or decreased in synchronism in order to adjust the forward or rearward thrust of the propulsion and steering system 101. Differential engine RPM of the waterjet configuration can be used to generate a yaw effect.

The steering deflectors 110 of the vessel 100 are operated in synchronism, that is, both port and starboard steering deflectors 210 move in unison to direct the jet stream. When the propulsion and steering system is controlled to only provide thrust in the longitudinal direction of the vessel as shown in manoeuvres numbered 501, 502, the deflectors are synchronised to the centre.

The vessel also has two basic rotation or yaw manoeuvres, numbered 503, 504. The vessel 100 in these rotational manoeuvres rotates to port or to starboard about a centre point in the vessel respectively. The directions of rotation are indicated with the curved arrows labelled 512. When the propulsion and steering system 101 is controlled to provide a yaw effect in an anti-clockwise direction 503, the steering deflectors are synchronised to port. When the propulsion and steering system is controlled to provide a yaw effect in a clockwise direction 504, the steering deflectors are synchronised to starboard.

The reverse ducts 212 can be operated either in synchronism or differentially. Synchronism is shown, for example, in manoeuvres numbered 501 and 502, where both reverse ducts 212 are either raised or lowered. The position of a reverse ducts 212 of waterjet units can be adjusted in synchronism to adjust the forward thrust vector of the vessel 100. Differential positions of reverse ducts 212 of waterjet units can also be adjusted to create yaw effects shown in manoeuvres numbered 503 and 504.

The basic manoeuvres available to the vessel 100 with a waterjet configuration and the associated vessel controls are summarised in Table 1 below. The manoeuvres are available to both the helmsperson operating the vessel control device(s), and the controller 200. A skilled person will understand that manoeuvres 501-506 can be made by the vessel with combinations of vessel controls other than the ones summarised in Table 1.

TABLE 1
Summary of Vessel Manoeuvres with Waterjet Configuration

| | | Port Waterjet Unit | | Starboard Waterjet Unit | |
|---|---|---|---|---|---|
| | | Reverse | Steering | Reverse | Steering |
| No. | Type of manoeuvre | Duct | Deflector | Duct | Deflector |
| 501 | Translation - ahead | Up | Centre | Up | Centre |
| 502 | Translation - astern | Down | Centre | Down | Centre |
| 503 | Rotation about | Below Zero Net | Port | Above Zero Net | Port |
| | centre - port | Forward Thrust | | Forward Thrust | |
| 504 | Rotation about | Above Zero Net | Starboard | Below Zero Net | Starboard |
| | centre - starboard | Forward Thrust | | Forward Thrust | |
| 505 | Translation - port | Down | Starboard | Up | Starboard |
| 506 | Translation - port | Up | Port | Down | Port |

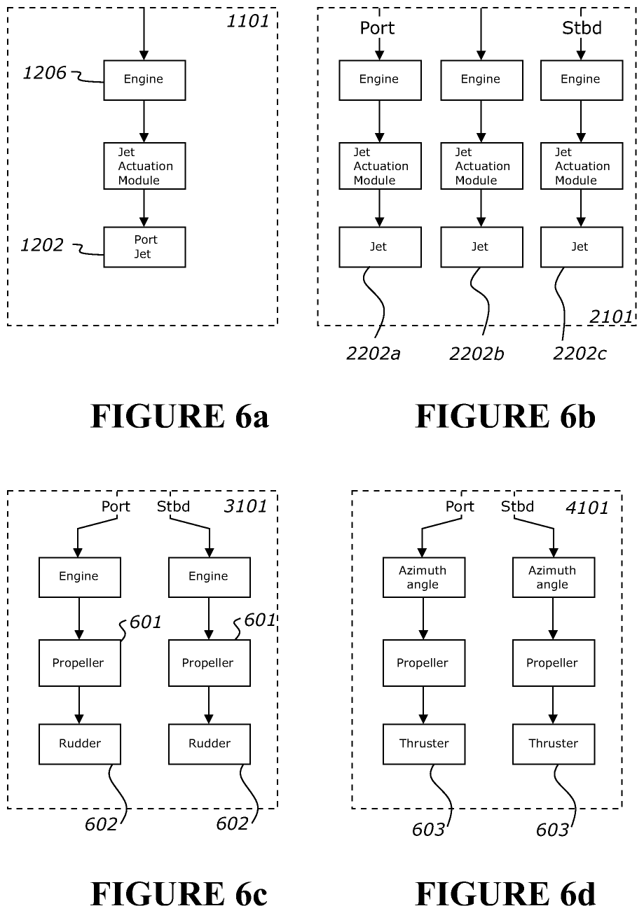

FIGS. 6a to 6d show other configurations of the propulsion and steering system 101. FIG. 6a shows the propulsion and steering system 1101 having a single waterjet unit 1202. FIG. 6b shows the propulsion and steering system 2101 having more than two waterjet units 2202a-2202c.

FIG. 6c shows the propulsion and steering system 3101 having propellers 601 and separate rudders 602. FIG. 6d shows the propulsion and steering system 4101 having steerable azimuth thrusters 603 instead of waterjet units. Similar to the propulsion and steering system with waterjet configurations, the propulsion and steering system shown in FIGS. 6c and 6d can also have a single propeller and rudder or azimuth thruster or more than two propellers and rudders or azimuth thrusters.

A skilled person will understand that different configurations of the propulsion and steering system 101 may have propulsion and steering components that can be positioned together or separately on the marine vessel and/or controlled together or separately by the controller 200. Further, the yaw effect applied to the vessel 100 is not necessarily directly related to steering of the vessel 100 implemented by the steering components of the propulsion and steering system. The steering components can only change the direction of the thrust vector but cannot increase or reduce the thrust vector. The engine RPM, reverse duct position or pitch of propeller can affect the magnitude of the thrust vector either synchronously or differentially.

The forward thrust vector of the vessel can be adjusted by adjusting the engine RPM of the propulsion and steering system in all configurations. Where the propulsion and steering system 3101 has a propeller and rudder configuration shown in FIG. 6c, the pitch of the propellers can also be adjusted to increase or reduce the vessel's 100 forward thrust vector.

Differential engine RPM of the propulsion and steering system can generate a yaw effect in the propeller and rudder configuration or the steerable azimuth thruster configuration. The different engine RPM can produce different amounts of thrust between different propellers or azimuth thrusters in the propulsion and steering system. The propulsion and steering system 3101 with a propeller and rudder configuration shown in FIG. 6c can also produce a yaw effect by adjusting steering through the rudders or by adjusting the differential pitch of propellers.

The propulsion and steering system 4101 with azimuth thrusters as shown in FIG. 6d can produce a yaw effect by adjusting steering through the azimuth or horizontal angles of the thrusters. In another example, a bow thruster and/or stern thruster (which may be a tunnel thruster for example) can be used to produce a yaw effect. The bow thruster and/or stern thruster can also produce lateral translation of the vessel by producing sideways thrust.

Any desired forces between the fender arrangement and the external structure may be achieved using one of or a combination of forward thrust and yaw effects. This allows the vessel 100 to keep stable against the external structure 103 regardless of forces from wind, waves, or tide that might move the vessel from the desired forces of contact. In other words, the desired forces are achieved as a result of a combination of the longitudinal thrust, yaw effects or lateral translation of the propulsion and steering system 101, 1101, 2101, 3101, 4101 and the external forces from wind, waves and tides.

Referring to FIG. 9, the control system of the marine vessel 100 may have a wind sensor 901 and/or a wave sensor 902. These can be applied for a marine vessel 100 having any of the other fender arrangements 1102-5102 and/or propulsion and steering systems 1101-4101 described herein.

A wind sensor 901 is used to determine changes in the wind load on the side of the vessel 100 based on wind speed measurements. In response to signals from the wind sensor 901, the controller 200 can determine a required operation of the propulsion and steering system 101 of the marine vessel to obtain or maintain desired forces between the fender arrangement 102 and the external structure 103 based on the force, pressure, torque or strain measurements from the force, pressure, torque or strain sensors. Wind speed and direction are measured by the wind sensor.

Similarly, a wave sensor 902 monitors wave action that will affect the side load on the vessel 100. The controller 200 may be configured to anticipate the impact of the wave action in response to signals from the wave sensor 902 and determine a required operation of the propulsion and steering system 101 of the marine vessel 100 to obtain or maintain a desired force or pressure between the fender arrangement 102 and the external structure 103 based on the force, pressure, torque or strain measurements from the force, pressure, torque or strain sensors 104. In an example, the wave sensor 902 includes a distance sensor, an optical sensor, radar sensor and/or a wave speed sensor. If the wave sensor 902 is an optical sensor such as a camera, LIDAR, laser range finder or 3D mapping laser, the anticipatory response can be initiated well before the wave action affects the marine vessel 100.

In other words, measurements from these additional sensors can be used by the controller 200 to anticipate changes in the forces against the external structure before the vessel is moved by external wind, waves and/or tides. Differential force/pressure in this situation may be really important. Without the additional wind or wave sensors, the controller only reacts to changes measured in the force sensing fender structure.

The control system can further include an inertial measurement unit (IMU) 903. The controller 200 is configured in response to signals from the IMU 903 to determine a required operation of the propulsion and steering system 101 of the marine vessel 100 to obtain or maintain desired attitude to offset sway or surge.

Any additional sensors may be used in a marine vessel 100 having any of the other fender arrangements 1102-5102 and/or propulsion and steering systems 1101-4101 described herein.

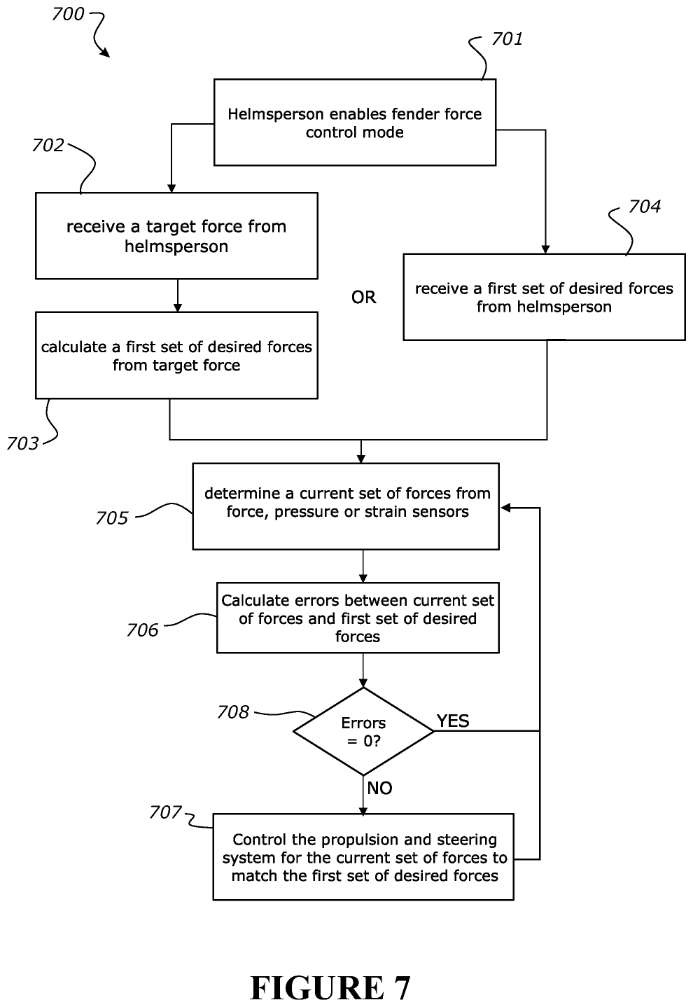

FIG. 7 shows an example method 700 for controlling the marine vessel 100 having propulsion and steering system 101 and fender arrangement 102 at the bow of the marine vessel. The marine vessel is controlled by a control system with a controller 200 and force, pressure, torque or strain sensors 104. The same method may be applied for a marine vessel 100 having any of the other fender arrangements 1102-5102 and/or propulsion and steering systems 1101-4101 described herein.

A helmsperson operates the vessel 100 using vessel control devices 128. When the helmsperson operates the vessel to be in contact or close to contact with the external structure 103, the helmsperson can enable 701 the fender force control mode through fender force control input device(s) 130. By enabling the fender force control mode before contacting the external structure, the initial impact forces on the structure can be more precisely controlled.

Once the fender force control mode is enabled, the controller 200 can receive 702 a target force through fender force control input device(s) 130. A set of desired forces to be obtained by each force, pressure, torque or strain sensor 104a, 104b on the fender arrangement 102 are calculated 703 from the target force. Alternatively, the controller 200 can receive 704 a set of desired forces between the fender arrangement and the external structure to be obtained by each force, pressure, torque or strain sensor 104 directly from the helmsperson through fender force control input device(s) 130.

The controller 200 further determines 705 a current set of forces between the fender arrangement 102 and the external structure 103 based on the force, pressure, torque or strain measurements from the force, pressure, torque or strain sensors 104.

Once the set of desired forces and the set of current forces are obtained, the errors between the current forces and desired forces are calculated 706. The controller 200 controls the propulsion and steering system 101 of the marine vessel 100 so that the current set of forces substantially matches 707 the first set of desired forces. If the errors are not zero, the propulsion and steering system is controlled to obtain zero errors. If the errors are zero, the propulsion and steering system is controlled to maintain zero errors. Any one or combination of manoeuvres shown in 501-506 can be used by the controller 200 to obtain or maintain the desired forces from the force, pressure, torque or strain sensors 104.

In an example, if the sum of the current set of forces is below the target force, the propulsion and steering system 101 is controlled to apply an increased forward thrust vector using manoeuvre 501. Applying as much force as possible against the external structure 103 improves the stability of the vessel 100.

If the sum of the current set of forces is above the target force, the propulsion and steering system is controlled to apply a reduced forward thrust vector using manoeuvre 501. This reduces the force applied against the external structure 103 and minimises damage to the external structure.

The controller 200 of marine vessel 100 in FIGS. 1 to 3 obtains a current set of forces that has a port-side force between the port side of the fender arrangement 102 and the external structure 103 and a starboard-side force between the starboard side of the fender arrangement 102 and the external structure 103. The port-side force and starboard-side force are measured by the port-side sensor 104a and starboard-side sensor 104b respectively. The set of desired forces also has a desired port-side force and a desired starboard-side force.

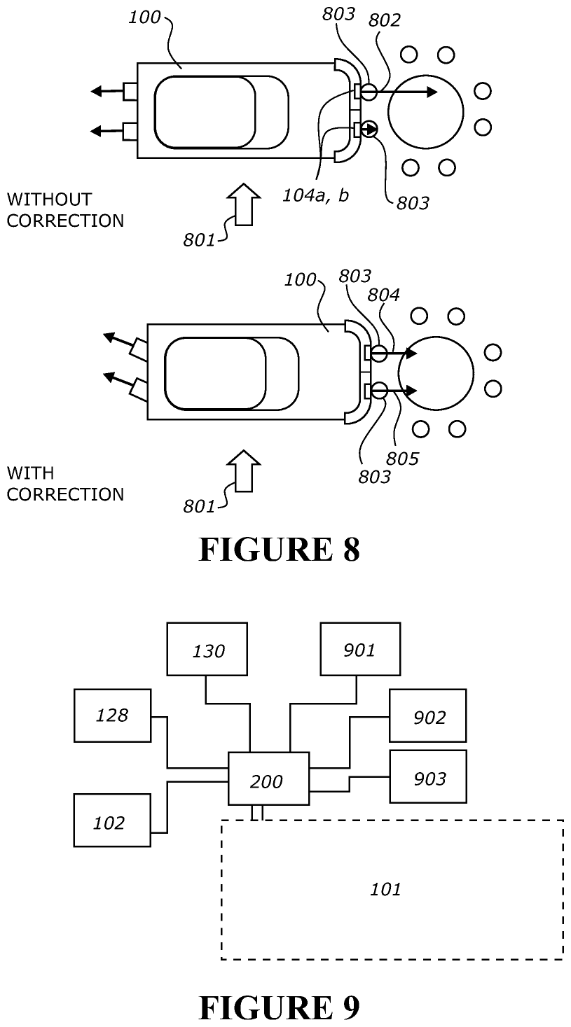

With reference to FIG. 8, the propulsion and steering system may be controlled to produce a yaw effect in order to change the relative proportion of forces between the port and starboard of the fender arrangement 102. The example in FIG. 8 show the marine vessel 100 applying the desired forces to the external structure when compensating for external wind and/or current forces 801 that are applied on the starboard side of the marine vessel.

The wind and/or current forces 801 being applied on the starboard side of the marine vessel 100 generates a port-side force 802 that is higher than the desired port-side force and a starboard-side force 803 that is lower than the desired starboard-side force. Therefore, the controller 200 calculates and minimises the errors between the current set of forces and the desired set of forces in accordance with steps 705 to 708 of method 700.

The controller 200 controls the propulsion and steering system 101 to carry out manoeuvre 503 shown to produce an anti-clockwise yaw effect to increase the starboard-side force 803 and decrease the port-side force 802 to reach the desired starboard-side force 805 and desired port-side force 804.

Following the same principle as above, if the wind and/or current applies an external force against the port side of the vessel 100, the port-side force would be lower than the desired port-side force and the starboard-side force would be higher than the desired starboard-side force. In this case, the controller 200 would control the propulsion and steering system to carry out manoeuvre 504 to produce a clockwise yaw effect to increase the port-side force and decrease the starboard-side force.

In another example, external forces may push the vessel 100 forward against the external structure 103 that exceed the desired forces between the fender arrangement 102 and the external structure 103. In this case, a backward thrust manoeuvre 502 shown in FIG. 5 can be applied to produce resultant forces that match the desired forces.

Once the errors between the current forces and the desired forces are minimised, the propulsion and steering system can be controlled to maintain the desired forces applied onto the external structure 103. Alternatively, the controller can receive a second set of desired forces between the fender arrangement and the external structure. In this case, the propulsion and steering system 101 of the marine vessel 100 is controlled so that the current set of forces substantially matches the second set of desired forces after the current set of forces substantially matches the first set of desired forces for a time period.

A helmsperson may wish to reduce the amount of moisture between the fender arrangement 102 and the external structure 103 by applying a lesser force against the external structure 103. When that lesser force is applied, the fender 102 can rub against the external structure. Friction from this rubbing action causes contact surfaces between the fender arrangement 102 and the external structure 103 to be relatively dry before the controller 200 causes the propulsion and steering system to apply a greater force against the external structure for greater friction and improved stability. The second set of desired forces can also be calculated from a second target force that is the sum of the second set of desired forces.

In some configurations of the fender arrangement 102, some or all of the current set of forces, the first set of desired forces and/or the second set of desired forces are generally in a substantially longitudinal direction of the marine vessel. These forces are based on force, pressure, torque or strain measurements from force, pressure, torque or strain sensors configured to obtain measurements in a substantially longitudinal direction of the marine vessel 100.

In some example configurations of the fender arrangement 102, some or all of the current set of forces, the first set of desired forces and/or the second set of desired forces are in a substantially vertical direction(s) relative to the length of the marine vessel. These forces are based on force, pressure, torque or strain measurements from force, pressure, torque or strain sensors configured to obtain measurements in a substantially vertical direction of the marine vessel 100.

In an example, desired forces in substantially vertical directions can at least partially be achieved by adjusting the pitch of trimmable nozzle(s) in waterjet units or the pitch of propellers in the propulsion and steering system 3101.

In some example configurations of the fender arrangement 102, some or all of the current set of forces, the first set of desired forces and/or the second set of desired forces are in a substantially lateral direction(s) relative to the length of the marine vessel. These forces are based on force, pressure, torque or strain measurements from force, pressure, torque or strain sensors configured to obtain measurements in a substantially lateral direction of the marine vessel 100.

In an example, desired forces in substantially lateral directions can at least partially be achieved by carrying out lateral motion manoeuvres 505 or 506 shown in FIG. 5.

Embodiments of the invention have been described by way of example only and modifications may be made thereto without departing from the scope of the invention.

1. A control system for a marine vessel having a propulsion and steering system and a fender arrangement at the bow of the marine vessel to provide contact between the marine vessel and an external structure, the control system comprising:
at least two force, pressure, torque or strain sensors to measure force, pressure, torque or strain that are indicative of forces between the fender arrangement and the external structure; and
a controller to control the operation of the propulsion and steering system of the marine vessel to substantially obtain or maintain desired forces between the fender arrangement and the external structure based on the force, pressure, torque or strain measurements from the at least two force, pressure, torque or strain sensors.

2. The control system of claim 1, wherein a sum of the desired forces forms a target force.

3. The control system of claim 2, wherein the controller is configured to increase a forward thrust vector applied by the propulsion and steering system if a sum of the forces between the fender arrangement and the external structure is below the target force, and/or wherein the controller is configured to reduce a forward thrust vector applied by the propulsion and steering system if a sum of the forces between the fender arrangement and the structure is above the target force.

4. (canceled)

5. The control system of claim 3, wherein the controller is configured to adjust engine RPM of the propulsion and steering system and/or to adjust a position of a reverse deflector of a waterjet unit of the propulsion and steering system and/or to adjust a pitch of a propeller of the propulsion and steering system to increase or reduce the forward thrust vector.

6. The control system of claim 1, wherein the at least two force, pressure, torque or strain sensors comprise:
at least one port-side sensor to measure force, pressure, torque or strain that is indicative of at least one port-side force between a port side of the fender arrangement and the external structure, and
at least one starboard-side sensor to measure force, pressure, torque or strain that is indicative of at least one starboard-side force between a starboard side of the fender arrangement and the external structure,
wherein the desired forces comprise at least one desired port-side force between the port side of the fender arrangement and the external structure and at least one desired starboard-side force between the starboard side of the fender arrangement and the external structure.

7. The control system of claim 6, wherein the controller is configured to:
control the propulsion and steering system to produce a yaw effect to increase the at least one starboard-side force and/or decrease the at least one port-side force if the at least one starboard-side force is lower than the at least one desired starboard-side force and/or if the at least one port-side force is higher than the at least one desired port-side force; or
control the steering and propulsion system to produce a yaw effect to increase the at least one port-side force and/or decrease the at least one starboard-side force if the at least one port-side force is lower than the at least one desired port-side force and/or if the at least one starboard-side force is higher than the at least one desired starboard-side force.

8. The control system of claim 7, wherein the controller is configured to adjust steering of the propulsion and steering system and/or to adjust differential engine RPM of the propulsion and steering system and/or to adjust differential positions of reverse deflectors of waterjet units of the propulsion and steering system and/or to adjust the differential pitch of propellers of the propulsion and steering system and/or to adjust thrust of a bow and/or stern thruster of the propulsion and steering system to produce the yaw effect.

9. The control system of claim 1, further comprising:
at least one wind sensor, wherein the controller is configured in response to signals from the wind sensor to determine a required operation of the propulsion and steering system of the marine vessel to obtain or maintain desired forces between the fender arrangement and the external structure based on the force, pressure, torque or strain measurements from the at least two force, pressure, torque or strain sensors.

10. The control system of claim 1, further comprising:
at least one wave sensor, wherein the controller is configured in response to signals from the wave sensor to determine a required operation of the propulsion and steering system of the marine vessel to obtain or maintain a desired force or pressure between the fender arrangement and the external structure based on the force, pressure, torque or strain measurements from the at least two force, pressure, torque or strain sensors.

11. (canceled)

12. The control system of claim 1, further comprising:
at least one inertial measurement unit (IMU), wherein the controller is configured in response to signals from the IMU to determine a required operation of the propulsion and steering system of the marine vessel to obtain or maintain desired attitude.

13. The control system of claim 1, further comprising:
at least one data storage to record the force, pressure, torque or strain measurements from the at least two force, pressure, torque or strain sensors, forces between the fender arrangement and the external structure and/or desired forces between the fender arrangement and the external structure.

14. A marine vessel comprising:
a propulsion and steering system;
a fender arrangement positioned at the bow of the marine vessel; and
a control system as claimed in claim 1, wherein the at least two force, pressure, torque or strain sensors are associated with the fender arrangement and configured to obtain force, pressure, torque or strain measurements indicative of forces between the fender arrangement and the external structure.

15. The marine vessel of claim 14, wherein a sum of the desired forces forms a target force, and wherein the control system is configured to control the propulsion and steering system for a sum of the forces between the fender arrangement and the external structure to be substantially the same as the target force.

16. The marine vessel of claim 15, wherein the control system is configured to increase a forward thrust vector applied by the propulsion and steering system if the sum of the forces between the fender arrangement and the external structure is below the target force.

17. The marine vessel of claim 15, wherein the control system is configured to reduce a forward thrust vector applied by the propulsion and steering system if the sum of the forces between the fender arrangement and the external structure is above the target force.

18. The marine vessel of claim 16, wherein the control system is configured to adjust engine RPM of the propulsion and steering system and/or to adjust a position of a reverse deflector of a waterjet unit of the propulsion and steering system and/or to adjust a pitch of a propeller of the propulsion and steering system to increase or reduce the forward thrust vector.

19. The marine vessel of claim 14, wherein the at least two force, pressure, torque or strain sensors comprise:
at least one port-side sensor to measure force, pressure, torque or strain that is indicative of at least one port-side force between a port side of the fender arrangement and the external structure, and
at least one starboard-side sensor to measure force, pressure, torque or strain that is indicative of at least one starboard-side force between a starboard side of the fender arrangement and the external structure,
wherein the desired forces comprise at least one desired port-side force between the port side of the fender arrangement and the external structure and at least one desired starboard-side force between the starboard side of the fender arrangement and the external structure; and
wherein the at least one port-side sensor is positioned substantially at the port side of the fender arrangement and the at least one starboard-side sensor is positioned substantially at the starboard side of the fender arrangement.

20. The marine vessel of claim 19, wherein the control system is configured to:
control the propulsion and steering system to produce a yaw effect to apply more force between the starboard side of the fender arrangement and the structure and/or less force between the port side of the fender arrangement and the structure if the at least one starboard-side force is lower than the at least one desired starboard-side force and/or if the at least one port-side force is higher than the at least one desired port-side force; and
control the propulsion and steering system to produce a yaw effect to apply more force to the port side of the fender and/or less force to the starboard side of the fender arrangement if the at least one port-side force is lower than the at least one desired port-side force and/or if the at least one starboard-side force is higher than the at least one desired starboard-side force.

21. The marine vessel of claim 19, wherein the control system is configured to adjust steering of the propulsion and steering system and/or to adjust differential engine RPM of the propulsion and steering system and/or to adjust differential positions of reverse deflectors of waterjet units of the propulsion and steering system and/or to adjust the differential pitch of propellers of the propulsion and steering system and/or to adjust thrust of a bow and/or stern thruster of the propulsion and steering system and/or to adjust the bow and stern thrusters of the propulsion and steering system to produce the yaw effect.

22. The marine vessel of any ene of claim 14, wherein some or all of the at least two force, pressure, torque or strain sensors are configured to obtain force, pressure, torque or strain measurements in a substantially longitudinal direction of the marine vessel, and/or wherein some or all of the at least two force, pressure, torque or strain sensors are configured to obtain force, pressure, torque or strain measurements in substantially vertical direction(s) relative to the length of the marine vessel, and/or wherein some or all of the at least two force, pressure, torque or strain sensors are configured to obtain force, pressure, torque or strain measurements in substantially lateral direction(s) relative to the length of the marine vessel.

23.-24. (canceled)

25. A method for controlling a marine vessel having a propulsion and steering system, a fender arrangement at the bow of the marine vessel to provide contact between the marine vessel and an external structure, and a control system of as claimed in claim 1, the method comprising:
receiving a first set of desired forces between the fender arrangement and the external structure;
determining a current set of forces between the fender arrangement and the external structure based on the force, pressure, torque or strain measurements from at least two force, pressure, torque or strain sensors associated with the fender arrangement; and
controlling the propulsion and steering system of the marine vessel so that the current set of forces substantially matches the first set of desired forces.

26.-36. (canceled)
